(19) United States
(12) Patent Application Publication
(10) Pub. No.: US 2011/0154717 A1
(43) Pub. Date: Jun. 30, 2011

(54) SHOCK-PROOF DEVICE FOR ELECTRIC MOSQUITO TRAP

(76) Inventor: CHAO JUNG HUNG, Taichung (TW)

(21) Appl. No.: 12/650,565

(22) Filed: Dec. 31, 2009

(51) Int. Cl. A01M 1/22; A01M 3/02

(52) U.S. Cl. 43/112; 43/137

(57) ABSTRACT

A shock-proof device for electric mosquito trap is a frame body capable of being arranged to two sides of an electric mosquito trap. The frame body has a plurality of polygonal through holes formed by thin sheets so as to avoid human body from touching an electric net of the electric mosquito trap. User will not have a fear of being electric shocked. The voltage of the electric mosquito trap can be thus raised for efficiently killing mosquitoes by single shock.

### FIELD OF THE INVENTION

The present invention relates to electric mosquito trap, and particular to an electric-shock-proof device for electric mosquito trap.

### DESCRIPTION OF THE PRIOR ART

Mosquitoes and bugs are always a disturbance of life. Chemical insecticide could kill the insects quickly, but also cause harm to human body and environment. An electric mosquito trap is thus developed so as to shock and disable the insects.

Prior electric mosquito trap with single electric net uses adjacent metal wires being conducted by opposite voltages to shock insects while insects touching the two wires of different voltages and forming a loop. However, the exposed wires are also dangerous to user and children so that people usually have obstacle for using such device. For that reason, some vendors lower the voltage of the electric mosquito trap to ease potential lethal risk of accidental electric shock and result in reducing the power of killing the insects with single shock. Sometimes the insects being shocked by such electric mosquito trap are temporary disabled. The user has to kill the disabled insects by hands. Eventually, there is also risk of disease for human to touch insects carrying germs, and the electric mosquito trap is not as effective as what it was expected.

Therefore, a trap with multiple electric nets is developed. With two or three layers of net conducted by opposite voltages to each other, human will not be shocked while touching any single net. Insects touching any two adjacent nets will cause an electric loop and being shocked. However, the probability of touching two layers in the same time is relatively low. Also, the manufacture cost for multiple nets is higher. The fear of exposed wires is also remained in such design.

Therefore, the inventor of the present invention provides a shock-proof device for electric mosquito trap to solve above disadvantages.

### SUMMARY OF THE PRESENT INVENTION

Accordingly, the primary object of the present invention is to provide a device to eliminate the fear of exposed wires and voltage concern for safety. To achieve the object, the present invention provides a shock-proof device for electric mosquito trap. The shock-proof device for electric mosquito trap is a frame body capable of being arranged to two sides of an electric mosquito trap. The frame body has a plurality of polygonal through holes. Each side of the polygonal through holes is below 10 mm and formed by thin sheet so as to avoid human body from touching an electric net of the electric mosquito trap. User will not have a fear of being electric shocked by exposed wires. The voltage of the electric mosquito trap can be thus raised for efficiently killing the mosquito by single shock.

### BRIEF DESCRIPTION OF THE DRAWINGS

FIG. 1 is a schematic view of an embodiment of the present invention.

FIG. 2 is a schematic view showing an assembling of the present invention and an electric mosquito trap.

FIG. 3 is a schematic view showing a combination of the present invention and an electric mosquito trap.

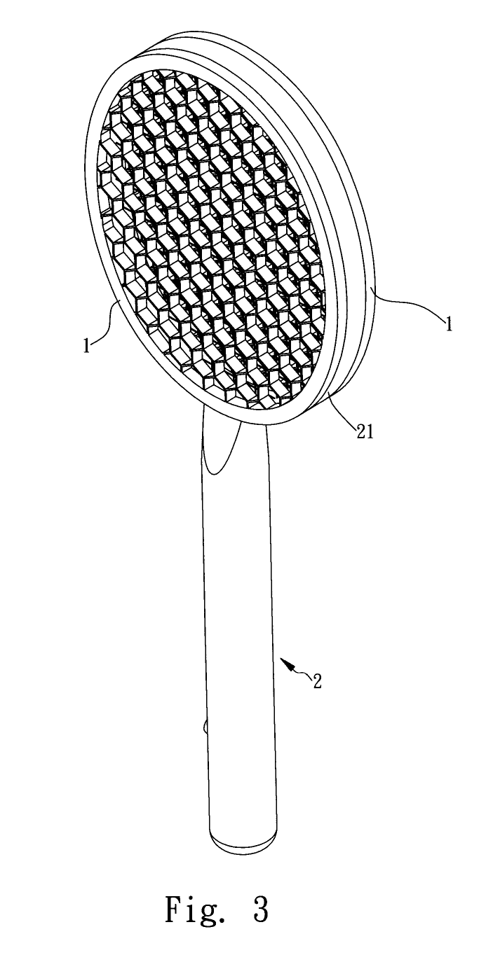

FIG. 4 is a front view showing the combination of the present invention and an electric mosquito trap.

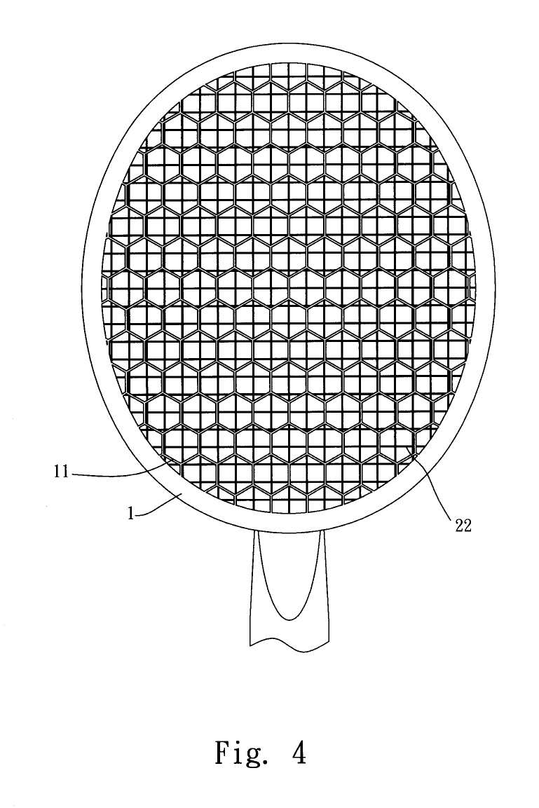

FIG. 5 is a cross section view showing the combination of the present invention and an electric mosquito trap.

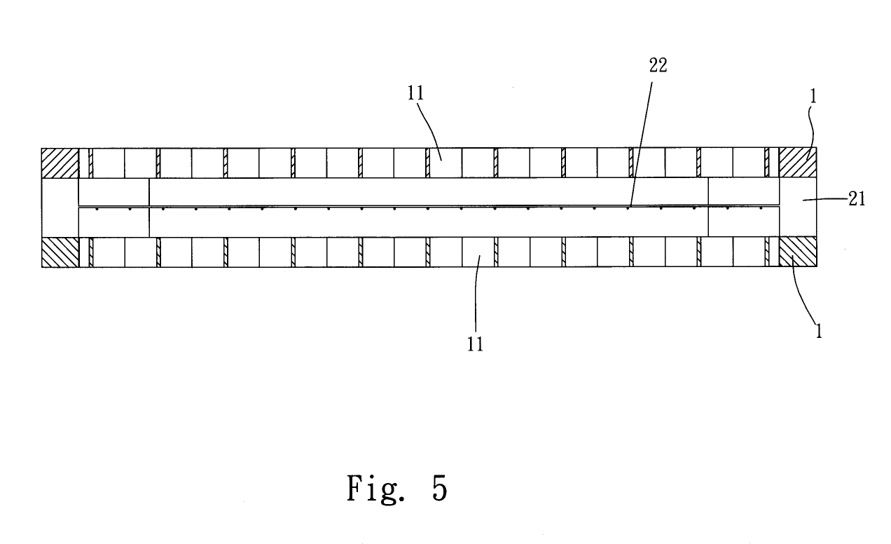

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

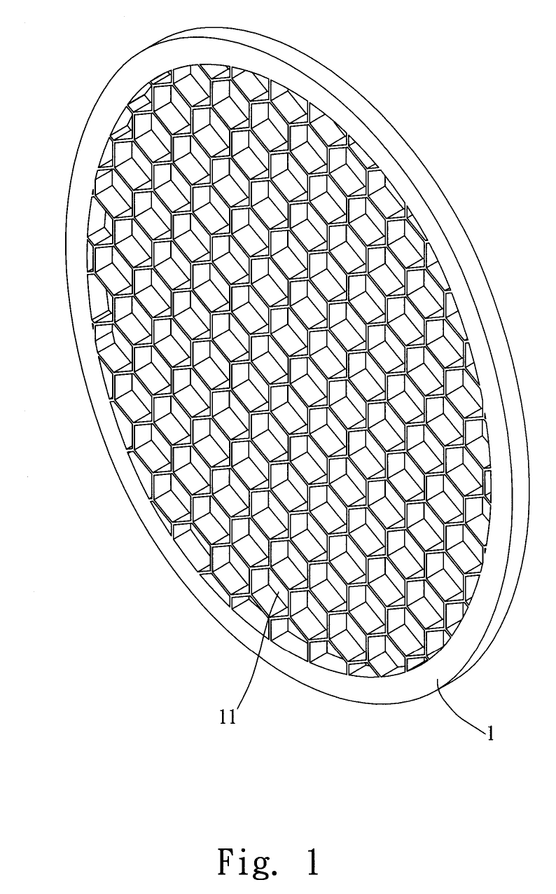

Referring to FIG. 1, an embodiment of a shock-proof device for electric mosquito trap according to the present invention includes the following components.

A frame body 1 can fit a trap frame 21 of an electric mosquito trap 2.

The frame body 1 has a plurality of polygonal through holes 11 within a scope of the frame body 1. Each side of the polygonal through holes 11 is a thin sheet 12. The sides of the polygonal through holes 11 are below 10 mm.

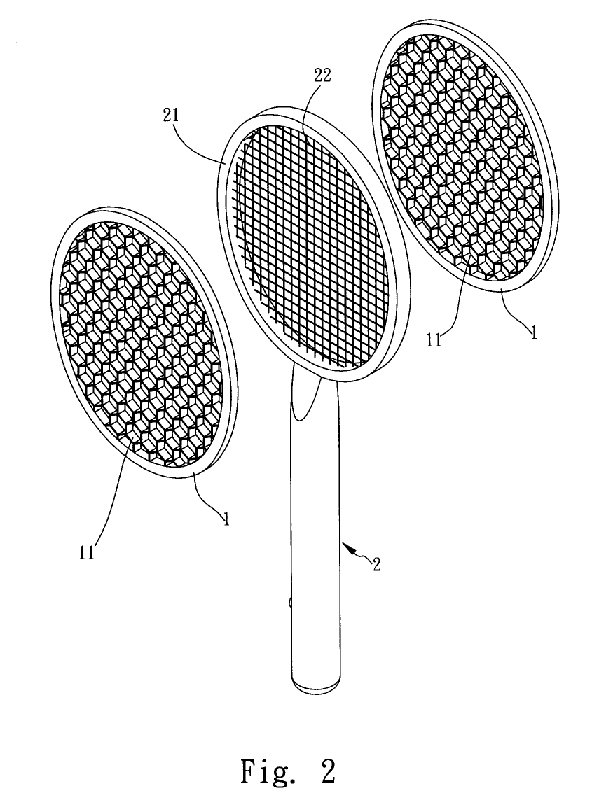

The frame body 1 is arranged to both two sides of the trap frame 21 as shown in FIG. 2.

The present invention has following advantages.

A. The thin sheets 12 of the polygonal through holes 11 are orthogonally arranged to the frame body 1 so that mosquitoes are easily passing through the polygonal through holes 11 and reaching an electric net 22 within the trap frame 21 while the electric mosquito trap 2 is swung.

B. The polygonal through holes 11 formed by the thin sheets 12 has low wind resistance so that the electric mosquito trap can be swung smoothly.

C. The polygonal through holes 11 of the frame body 1 can not be passed by human body. With a predetermined width of the thin sheets 12, the human body can be surely avoided from touching the electric net 22.

D. User will not have fear to use such electric mosquito trap with the shock-proof device. E. User don't have to choice an expensive mosquito trap with multiple electric nets.

F. With the shock-proof device, the voltage of the electric mosquito trap can be raised for efficiently killing the mosquito by single shock.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A shock-proof device for electric mosquito trap comprising:
a frame body having a plurality of through holes; the frame body being arranged to both two sides of a trap frame of the electric mosquito trap.

2. The shock-proof device for electric mosquito trap as claimed in claim 1, wherein the through holes of the frame body is polygonal.

3. The shock-proof device for electric mosquito trap as claimed in claim 2, wherein each side of the polygonal through holes is below 10 mm.

4. The shock-proof device for electric mosquito trap as claimed in claim 1, wherein the through holes of the frame body are formed by thin sheets.

5. The shock-proof device for electric mosquito trap as claimed in claim 1, wherein the frame body fits the trap frame of the electric mosquito trap.
